(19) United States
(12) Patent Application Publication
(10) Pub. No.: US 2019/0070975 A1
(43) Pub. Date: Mar. 7, 2019

(54) ACCUMULATOR ARRANGEMENT FOR AN ELECTRIC OR HYBRID VEHICLE

(71) Applicant: Mahle International GmbH, Stuttgart (DE)

(72) Inventors: Ingo Haeusler, Esslingen (DE); Ruediger Knauss, Kernen i.R. (DE); Peter Nowak, Stuttgart (DE); Karl-Ulrich Schmid-Walderich, Tuebingen (DE)

(21) Appl. No.: 16/121,608

(22) Filed: Sep. 4, 2018

(30) Foreign Application Priority Data
Sep. 5, 2017 (DE) 102017215610.4

(51) Int. Cl. B60L 11/18; H01M 10/625; H01M 10/613; H01M 10/48; H01M 10/63; H01M 2/10

(52) U.S. Cl. CPC B60L 11/1874; B60L 11/1879; H01M 10/625; H01M 2220/20; H01M 10/486; H01M 10/63; H01M 2/1077; H01M 10/613

(57) ABSTRACT

An accumulator arrangement for an electric or hybrid vehicle may include at least one battery module on which a temperature control unit is secured to transmit heat. The temperature control unit may include a first inlet nozzle and a first outlet nozzle. The arrangement may also include a channel structure including a second inlet nozzle and a second outlet nozzle. The inlet nozzles and the respective outlet nozzles may be connected to each other to direct cooling medium via a respective pipe piece. At least one of i) the inlet nozzles and ii) the outlet nozzles may each have an internal cylindrical sealing face and the respective pipe piece may have at both sides at least one external annular seal. An annular seal of the respective pipe piece may be secured to the sealing face of one of a corresponding inlet and outlet nozzle in a frictionally engaging manner.

### CROSS-REFERENCE TO RELATED APPLICATIONS

This application claims priority to German Patent Application No. DE 10 2017 215 610.4, filed on Sep. 5, 2017, the contents of which are hereby incorporated by reference in its entirety.

### TECHNICAL FIELD

The invention relates to an accumulator arrangement for an electric or hybrid vehicle.

### BACKGROUND

Accumulator arrangements—also referred to as traction batteries—for electric or hybrid vehicles are already known from the prior art. An accumulator arrangement generally comprises a plurality of battery modules, in which a plurality of individual cells are connected to each other in parallel or in series. The battery modules are arranged in a two-part battery housing and releasably secured. In order to control the temperature of the battery modules, a cooling system is generally installed in the battery housing of the accumulator arrangement. The heat produced in the battery modules can be discharged to a cooling medium in the cooling system and the battery modules can be cooled in this manner. Alternatively, the battery modules in the event of a low external temperature can also be heated by hot cooling medium.

The cooling system may in this instance, for example, comprise an individual cooling medium module which is arranged in abutment with the battery modules and so as to transmit heat. A distribution of the cooling medium to the individual battery modules does not take place in this instance. Such a cooling system is known, for example, from DE 10 2012 206 495 A1. Alternatively, in the cooling system the cooling medium can be guided to the individual battery modules and the individual battery modules can accordingly be cooled or heated individually by means of a temperature control unit in each case. The distribution of the cooling medium is carried out in this instance via supply and return pipes which are secured in the battery housing. When the battery modules are assembled or disassembled in the battery housing, the respective temperature control units are also connected to the channel structure or released from it. When the temperature control units are connected to the channel structure, the supply and return pipes of the channel structure are connected to the individual temperature control units by means of standard connections so as to direct cooling medium. To this end, the standard connections of the temperature control units and the supply and return pipes are connected to each other by means of individual lines. Tolerances between the temperature control units and the supply and return pipes are in this instance compensated for by means of the flexible lines. Accordingly, when the temperature control units are released from the channel structure, the individual connections have to be released again.

A connection and a release of the temperature control units are carried out by hand and involve a high level of complexity. The standard connections of the temperature control units and the supply and return pipes additionally have to be accessible in the battery housing, whereby the structural spatial requirement in the battery housing is increased in a disadvantageous manner.

### SUMMARY

An object of the invention is therefore to provide for an accumulator arrangement of the generic type an improved or at least alternative embodiment in which the disadvantages described are overcome.

This object is achieved according to the invention by the subject-matter of the independent claim(s). Advantageous embodiments are set out in the dependent claim(s).

The present invention is based on the general notion of implementing in an accumulator arrangement for an electric or hybrid vehicle a connection and a release of temperature control units via plug-and-play. The accumulator arrangement has in this instance at least one battery module on which a temperature control unit is secured in abutment and so as to transmit heat. The temperature control unit has a first inlet nozzle for supplying a cooling medium and a first outlet nozzle for discharging the cooling medium. The accumulator arrangement further has a channel structure which directs cooling medium and which for each temperature control unit has a second inlet nozzle for supplying the cooling medium and a second outlet nozzle for discharging the cooling medium. The respective inlet nozzles and the respective outlet nozzles are connected to each other so as to direct cooling medium by means of a pipe piece, respectively. According to the invention the respective inlet nozzles and/or the respective outlet nozzles each have an internal cylindrical sealing face and the respective pipe piece has at both sides at least one external annular seal. The respective seal of the pipe piece is in this instance secured to the corresponding sealing face of the respective inlet nozzle and/or the respective outlet nozzle in a frictionally engaging manner.

When the temperature control unit of the respective battery module is connected to the channel structure, the pipe piece is secured in the respective inlet nozzles or in the respective outlet nozzles. The annular seals of the pipe piece are in this instance in abutment with the cylindrical sealing faces of the respective inlet nozzles or the respective outlet nozzles and form in each case a frictional engagement therewith. The pipe piece is thereby secured in the respective inlet nozzle or in the respective outlet nozzle and the cooling medium can be directed between the respective inlet nozzles or the respective outlet nozzles via the pipe piece in a leakage-free manner. When the temperature control unit is released from the channel structure, the pipe piece is removed from the respective inlet nozzles or from the respective outlet nozzles so that the frictional engagement between the seals of the pipe piece and the sealing faces of the respective inlet nozzles or the respective outlet nozzles is released. In this manner, the temperature control unit of the respective battery module can be connected via plug-and-play to the channel structure of the battery housing or released therefrom with reduced complexity and in a simplified manner.

Advantageously, the respective inlet nozzles and/or the respective outlet nozzles and the respective pipe piece can be secured to each other by the respective seal of the pipe piece. The annular seal of the pipe piece may further form a frictional engagement over the entire cylindrical sealing face so that the pipe piece can be displaced axially in the respective inlet nozzles or in the respective outlet nozzles. In this manner, axial tolerances between the temperature control unit and the channel structure may be compensated for.

Advantageously, there is provision for the respective annular seal of the pipe piece to be secured in a sealing groove in a positive-locking manner. The sealing groove prevents displacement of the seal on the pipe piece so that the temperature control unit can be securely connected to the channel structure. There is also provision for the respective annular seal to comprise a resilient material. The resilient material enables together with an advantageous embodiment of the sealing groove compensation for radial tolerances between the temperature control unit and the channel structure and the pipe piece may further be secured in a leakage-free manner in the respective inlet nozzles or in the respective outlet nozzles. Advantageously, the respective pipe piece may be rigid so that a connection and a release of the temperature control units in comparison with flexible and sometimes cumbersome lines are simplified. The pipe piece preferably comprises in this instance a plastics material or a metal. The sealing faces of the respective outlet nozzles and/or the respective inlet nozzles may advantageously be constructed in an identical manner and the pipe piece constructed in a mirror-symmetrical manner. In this manner, incorrect assembly can in particular be prevented and the production costs can be reduced.

In a development of the accumulator arrangement according to the invention, there is advantageously provision for the at least one battery module on a module housing to have at least two retention clamps in which the respective pipe piece is secured in a clamping manner. The pipe piece may already previously be secured to the respective battery module and connected to the first inlet nozzle or to the second outlet nozzle of the temperature control unit of the respective battery module so as to direct cooling medium. When the respective battery module is secured in the battery housing, the respective temperature control unit can then at the same time also be connected to the channel structure via plug-and-play so as to direct cooling medium. The connection of the temperature control unit to the channel structure is in this instance limited to pushing the pipe piece into the corresponding second inlet nozzle or into the corresponding second outlet nozzle of the channel structure. Accordingly, the release of the temperature control unit from the channel structure is also simplified. Advantageously, two pipe pieces for the respective inlet nozzles and for the respective outlet nozzles are secured on the at least one battery module in a clamping manner. Advantageously, the respective inlet nozzles and the respective outlet nozzles can then be connected at the same time via the respective pipe pieces so as to direct cooling medium. The time for the connection and for the release of the temperature control unit and on the whole for securing the respective battery module in the battery housing is thereby significantly reduced.

There is further provision for the pipe piece to have at both sides an annular stop formation and to be axially secured to the respective retention clamps by means of the respective stop formations. In this manner, undesirable displacement of the pipe piece in the respective inlet nozzles or in the respective outlet nozzles can be prevented and an undesirable release of the connection directing cooling medium between the temperature control unit and the channel structure and a leakage of the cooling medium can be prevented. In addition, a connection of the temperature control unit to the channel structure is also thereby simplified.

In order to prevent a leakage of the cooling medium when the temperature control unit is released from the channel structure, there is advantageously provision for the second inlet nozzle and/or the second outlet nozzle of the channel structure each to have a non-return valve. In this instance, the respective non-return valve can be opened when the pipe piece is secured in the second inlet nozzle or in the second outlet nozzle and can be closed when the pipe piece is released from the second inlet nozzle or the second outlet nozzle. When the temperature control units are released from the channel structure, the pipe pieces can then simply be removed from the respective inlet nozzles or from the respective outlet nozzles and a leakage of the cooling medium is prevented by the non-return valves.

Advantageously, there is also provision for the channel structure to be secured to a battery housing of the accumulator arrangement. In this instance, the at least one battery module is connected to the channel structure so as to direct cooling medium and is releasably secured to the battery housing. When the battery module is secured in the battery housing, the battery module may, for example, initially be secured in the battery housing and, subsequently, the respective temperature control unit may be connected to the channel structure so as to direct cooling medium. Alternatively, the temperature control unit may initially be connected to the channel structure and subsequently the battery module may be secured in the battery housing.

On the whole, in the accumulator arrangement according to the invention a connection and a release of the temperature control unit of the respective battery module via plug-and-play are possible with reduced complexity and in a simplified manner. Furthermore, the structural spatial requirement for the respective battery modules in the battery housing is advantageously reduced and the accumulator arrangement may be constructed in a more compact and lightweight manner.

Other important features and advantages of the invention will be appreciated from the dependent claims, the drawings and the associated description of the Figures with reference to the drawings.

Of course, the features mentioned above and those about to be explained below can be used not only in the combination set out but also in other combinations or alone, without departing from the scope of the present invention.

Preferred embodiments of the invention are illustrated in the drawings and are explained in greater detail in the following description, wherein identical reference numerals refer to components which are identical or similar or functionally identical.

### BRIEF DESCRIPTION OF THE DRAWINGS

In the schematic drawings:

FIG. 1 is a view of an accumulator arrangement according to the invention with a plurality of battery modules;

FIG. 2 is a view of a battery module with pipe pieces secured to the battery module;

FIG. 3 is a view of a battery module with pipe pieces connected to a channel structure;

FIG. 4 is a sectioned view of a pipe piece on respective inlet nozzles or on respective outlet nozzles.

### DETAILED DESCRIPTION

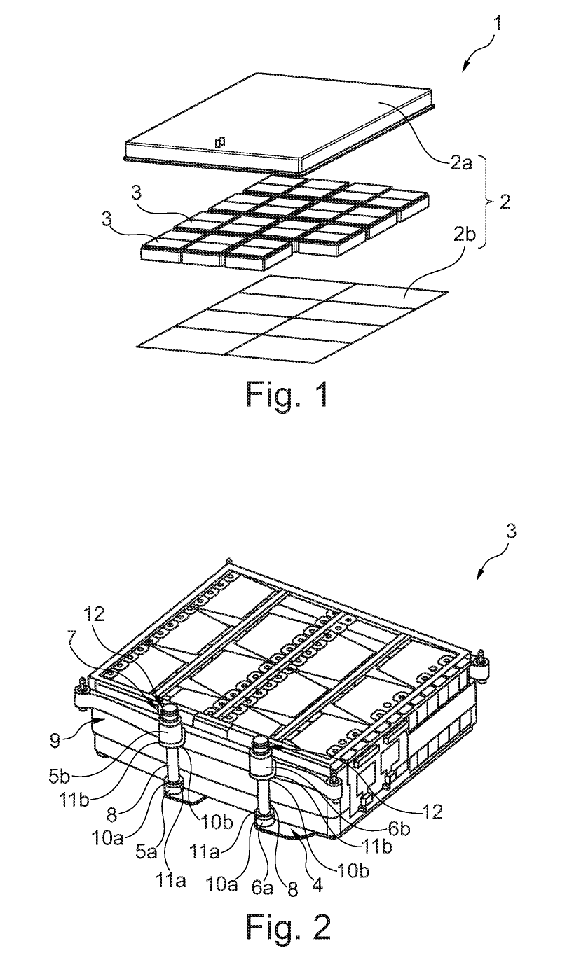

FIG. 1 is a view of an accumulator arrangement 1 according to invention for an electric or hybrid vehicle having a battery housing 2. The battery housing 2 has a housing portion 2a and a cover 2b and surrounds a plurality of battery modules 3 which are releasably secured in the battery housing 2. The battery modules 3 can be secured in the housing portion 2a, for example, in a positive-locking or non-positive-locking manner and the housing portion 2a with the battery modules 3 can be, for example, secured below the electric or hybrid vehicle.

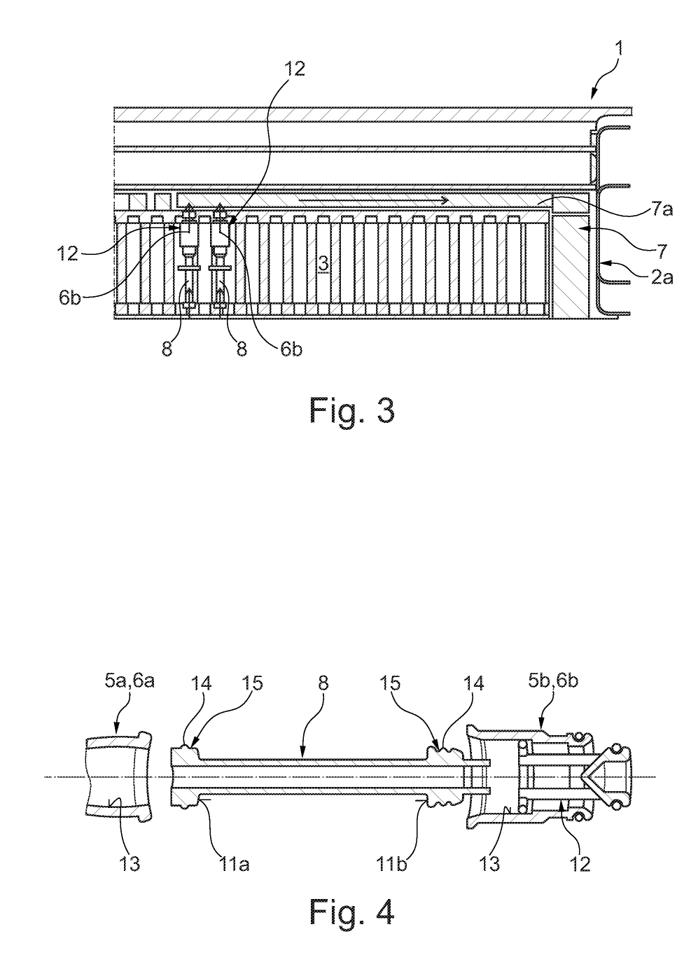

FIG. 2 and FIG. 3 are views of the battery module 3. On the battery module 3 a temperature control unit 4 is secured in abutment and so as to transmit heat and has a first inlet nozzle 5a for supplying a cooling medium and a first outlet nozzle 6a for discharging the cooling medium. The accumulator arrangement 1 further has according to FIG. 3 a cooling-medium-directing channel structure 7 having a cooling medium channel 7a which has for the respective temperature control unit 4 a second inlet nozzle 5b for supplying the cooling medium and a second outlet nozzle 6b for discharging the cooling medium. In FIG. 3, there are provided on the battery module 3 in contrast to FIG. 2 two outlet nozzles 6b for discharging the cooling medium from the temperature control unit 4 which are connected in parallel. The channel structure 7 with the cooling channels 7a is secured in the housing portion 2a of the battery housing 2.

The respective inlet nozzles 5a and 5b and the respective outlet nozzles 6a and 6b are connected to each other so as to direct cooling medium by means of a pipe piece 8. The respective pipe piece 8 is rigid and may, for example, comprise a plastics material or a metal. A module housing 9 of the battery module 3 has for each of the two pipe pieces 8 two retention clamps 10a and 10b in which the respective pipe pieces 8 are secured in a clamping manner. The respective pipe piece 8 may already be previously secured to the battery module 3 and connected to the first inlet nozzle 5a and to the first outlet nozzle 6a so as to direct cooling medium. When the temperature control unit 4 is connected to the channel structure 7, the respective pipe pieces 8 may be pushed into the second inlet nozzle 5b and into the second outlet nozzle 6b of the channel structure 7 with reduced complexity and the temperature control unit 4 may be connected in this manner via plug-and-play to the channel structure 7 in a cooling-medium-directing manner. The connection of the temperature control unit 4 to the channel structure 7 is thereby advantageously simplified to an insertion of the respective pipe pieces 8 in the second inlet nozzles 5b and the second outlet nozzles 6b. The time for the assembly and disassembly of the battery module 3 in the battery housing 2 is thereby significantly reduced.

In order to prevent undesirable displacement of the respective pipe pieces 8 in the inlet nozzles 5a and 5b and in the outlet nozzles 6a and 6b, the respective pipe piece 8 has at both sides an annular stop formation 11a and 11b. The respective stop formations 11a and 11b place the respective pipe piece 8 on the respective retention clamps 10a and 10b in an axially secure manner. In this manner, a leakage of the cooling medium can be prevented and the connection of the temperature control unit 4 to the channel structure 7 can be further simplified. In order also to prevent a leakage of the cooling medium from the channel structure 7 when the temperature control unit 4 is released from the channel structure 7, the second inlet nozzle 5b and the second outlet nozzle 6b each have a non-return valve 12. In this instance, the respective non-return valve 12 is opened when the pipe piece 8 is secured in the second inlet nozzle 5b or in the second outlet nozzle 6b and closed when the pipe piece 8 is released from the second inlet nozzle 5b or the second outlet nozzle 6b. When the temperature control unit 4 is released from the channel structure 7, the respective pipe pieces 8 from the inlet nozzle 5b and the outlet nozzle 6b are then mechanically closed and a leakage of the cooling medium is prevented.

FIG. 4 is a sectioned view of the pipe piece 12 with the inlet nozzles 5a and 5b or with the outlet nozzles 6a and 6b. The inlet nozzles 5a and 5b and the outlet nozzles 6a and 6b each have an internal cylindrical sealing face 13. The respective pipe piece 8 has at each of the two sides an external annular resilient seal 14 which is secured in a sealing groove 15 in a positive-locking manner. The sealing groove 15 prevents a displacement of the seal 14 on the pipe piece 8 and additionally enables compensation for radial tolerances between the pipe piece 8 and the inlet nozzles 5a and 5b or the outlet nozzles 6a and 6b.

When the temperature control unit 4 of the respective battery module 3 is connected to the channel structure 7, the pipe piece 8 is pushed into the inlet nozzles 5a and 5b or into the outlet nozzles 6a and 6b. The annular seals 14 of the pipe piece 12 are then secured to the cylindrical sealing faces 15 of the inlet nozzles 5a and 5b or the outlet nozzles 6a and 6b in a frictionally engaging manner. The pipe piece 8 is thereby secured in the inlet nozzles 5a and 5b or in the outlet nozzles 6a and 6b so as to direct cooling medium in a leak-free manner. When the temperature control unit 4 is released from the channel structure 7, the pipe piece 8 is removed from the inlet nozzles 5a or 5b or from the outlet nozzles 6a and 6b and the frictional engagement between the seals 14 of the pipe piece 8 and the sealing faces 13 of the inlet nozzles 5a and 5b or the outlet nozzles 6a and 6b is released. The respective seal 14 of the pipe piece 8 can be secured to the entire sealing face 13 in a frictionally engaging manner so that axial tolerances between the pipe piece 8 and the inlet nozzles 5a and 5b or the outlet nozzles 6a and 6b can also be compensated for. Furthermore, the respective sealing faces 13 of the inlet nozzles 5a and 5b and the outlet nozzles 6a and 6b are constructed in an identical manner and the pipe piece 12 is constructed in a mirror-symmetrical manner. Advantageously, incorrect assembly can thus be prevented and the production costs can be reduced.

On the whole, in the accumulator arrangement 1 according to the invention the temperature control unit 4 of the battery module 3 can be connected with reduced complexity via plug-and-play to the channel structure 7 and released therefrom. Furthermore, the structural spatial requirement for the respective battery modules 3 in the battery housing 2 is advantageously reduced and the accumulator arrangement 1 can be constructed in a more compact and lightweight manner.

1. An accumulator arrangement for an electric or hybrid vehicle, comprising:
at least one battery module on which a temperature control unit is secured in abutment to transmit heat;
the temperature control unit including a first inlet nozzle for supplying a cooling medium and a first outlet nozzle for discharging the cooling medium;
a channel structure which directs the cooling medium and which for the temperature control unit includes a second inlet nozzle for supplying the cooling medium and a second outlet nozzle for discharging the cooling medium;
the inlet nozzles and the respective outlet nozzles connected to each other to direct cooling medium via a respective pipe piece;
at least one of i) the inlet nozzles and ii) the outlet nozzles each having an internal cylindrical sealing face and the respective pipe piece having at both sides at least one external annular seal;
wherein an annular seal of the respective pipe piece is secured to the sealing face of one of a corresponding inlet nozzle and a corresponding outlet nozzle in a frictionally engaging manner.

2. The accumulator arrangement according to claim 1, wherein the at least one annular seal is secured in a sealing groove in a positive-locking manner.

3. The accumulator arrangement according to claim 1, wherein the at least one annular seal includes a resilient material.

4. The accumulator arrangement according to claim 1, wherein the respective pipe piece is composed of one of a plastics material and a metal.

5. The accumulator arrangement according to claim 1, wherein:
the sealing faces of the at least one of i) the inlet nozzles and ii) the outlet nozzles are structured in an identical manner; and
the respective pipe piece is structured in a mirror-symmetrical manner.

6. The accumulator arrangement according to claim 1, wherein the at least one battery module includes a module housing on which at least two retention clamps are arranged, in each of which a corresponding pipe piece is secured in a clamping manner.

7. The accumulator arrangement according to claim 6, wherein:
the respective pipe piece includes at both sides an annular stop formation; and
the respective pipe piece is axially secured to a respective retention clamp via a respective stop formation.

8. The accumulator arrangement according to claim 1, wherein at least one of the second inlet nozzle and the second outlet nozzle includes a non-return valve.

9. The accumulator arrangement according to claim 8, wherein a respective non-return valve is opened when the respective pipe piece is secured in one of the second inlet nozzle and the second outlet nozzle, and is closed when the respective pipe piece is released from one of the second inlet nozzle and the second outlet nozzle.

10. The accumulator arrangement according to claim 1, further comprising:
a battery housing, the channel structure secured to the battery housing;
wherein the at least one battery module is connected to the channel structure to direct cooling medium and is releasably secured to the battery housing.

11. The accumulator arrangement according to claim 1, wherein the at least one of i) the inlet nozzles and ii) the outlet nozzles and the respective pipe piece are secured to each other via the annular seal of the respective pipe piece in a frictionally engaging and axially displaceable manner compensating for axial tolerances between the temperature control unit and the channel structure.

12. The accumulator arrangement according to claim 2, wherein the at least one annular seal includes a resilient material.

13. The accumulator arrangement according to claim 2, wherein:
the sealing faces of the at least one of i) the inlet nozzles and ii) the outlet nozzles are structured in an identical manner; and
the respective pipe piece is structured in a mirror-symmetrical manner.

14. The accumulator arrangement according to claim 13, wherein the at least one battery module includes a module housing on which at least two retention clamps are arranged, in each of which a corresponding pipe piece is secured in a clamping manner.

15. The accumulator arrangement according to claim 14, wherein:
the respective pipe piece includes at both sides an annular stop formation; and
the respective pipe piece is axially secured to a respective retention clamp via a respective stop formation.

16. The accumulator arrangement according to claim 13, wherein at least one of the second inlet nozzle and the second outlet nozzle includes a non-return valve, the non-return valve opened when the respective pipe piece is secured in one of the second inlet nozzle and the second outlet nozzle, and closed when the respective pipe piece is released from one of the second inlet nozzle and the second outlet nozzle.

17. An accumulator arrangement for an electric or hybrid vehicle, comprising:
at least one battery module on which a temperature control unit is secured in abutment to transmit heat;
the temperature control unit including a first inlet nozzle for supplying a cooling medium and a first outlet nozzle for discharging the cooling medium;
a channel structure which directs the cooling medium and which for the temperature control unit includes a second inlet nozzle for supplying the cooling medium and a second outlet nozzle for discharging the cooling medium;
the inlet nozzles and the respective outlet nozzles connected to each other to direct cooling medium via a respective pipe piece, the respective pipe piece composed of at least one of a plastic material and a metal;
at least one of i) the inlet nozzles and ii) the outlet nozzles each having an internal cylindrical sealing face and the respective pipe piece having at both sides at least one external annular seal including a resilient material;
wherein an annular seal of the respective pipe piece is secured to the sealing face of one of a corresponding inlet nozzle and a corresponding outlet nozzle in a frictionally engaging manner.

18. The accumulator arrangement according to claim 17, wherein the at least one battery module includes a module housing on which at least two retention clamps are arranged, in each of which a corresponding pipe piece is secured in a clamping manner.

19. The accumulator arrangement according to claim 18, wherein at least one of the second inlet nozzle and the second outlet nozzle includes a non-return valve.

20. An accumulator arrangement for an electric or hybrid vehicle, comprising:
at least one battery module;
a temperature control unit arranged on and abutting the at least one battery module such that heat is transferable, the temperature control unit including a first inlet nozzle configured to supply a cooling medium and a first outlet nozzle configured to discharge the cooling medium;
a channel structure structured and arranged to direct the cooling medium, the channel structure including a second inlet nozzle configured to supply the cooling medium to the temperature control unit and a second outlet nozzle configured to discharge the cooling medium from the temperature control unit;
a first pipe piece connecting the first inlet nozzle to the first outlet nozzle and a second pipe piece connecting the second inlet nozzle to the second outlet nozzle;
wherein at least one of i) the first inlet nozzle and the second inlet nozzle and ii) the first outlet nozzle and the second outlet nozzle respectively have an internal cylindrical sealing face secured in a frictionally engaging manner to a corresponding annular seal of a respective one of the first pipe piece and the second pipe piece.
